(19) United States
(12) Patent Application Publication
(10) Pub. No.: US 2005/0201478 A1
(43) Pub. Date: Sep. 15, 2005

(54) Modulation in a mobile telecommunications system

(76) Inventors: Holger Claussen, Swindon (GB); Reza Hamid Karimi, Swindon (GB)

Correspondence Address: Docket Administrator (Room 3J-219);Lucent Technologies Inc., 101 Crawfords Corner Road, Holmdel, NJ, 07733-3030, US

(21) Appl. No.: 10/797,166

(22) Filed: Mar. 10, 2004

(51) Int. Cl. H04L 5/12

(52) U.S. Cl. 375/261; 375/267

(57) ABSTRACT

A method of communication of data in a mobile telecommunications network involves at a transmitter first grouping the data into a first sequence of bits and a second sequence of bits. There is then a step of modulating a signal with the bits of the first sequence so that the bits of the first sequence have a first level of communication error protection provided by the modulation and with the bits of the second sequence so that the bits of the second sequence have a second level of communication error protection provided by the modulation less than the first level of communication error protection. The signal is then transmitted. At a receiver, estimates of the bits of the first sequence from the signal are detected and contributions to the signal corresponding to the estimates are determined and cancelled from the signal so as to produce a modified signal. Estimates of the bits of the second sequence are then detected from the modified signal.

### FIELD OF THE INVENTION

The present invention relates to mobile telecommunications; in particular, to a method of communication of data in a mobile telecommunications network, to a mobile telecommunications network, to a transmitter and to a receiver.

The invention was made in the course of work relating to multiple-input multiple-output (MIMO) telecommunications systems, but the invention can relate to other telecommunications systems.

### DESCRIPTION OF THE RELATED ART

Multiple-input multiple-output (MIMO) techniques are well known, and the reader is referred to, for example, G. J Foschini and M. J. Gans “On limits of wireless communications in a fading environment when using multiple antennas”, Wireless Personal Communications, vol. 6, pp. 311-335, 1998, as background. MIMO radio links have been suggested for use in code division multiple access (CDMA) networks, such as Universal Mobile Telecommunications System (UMTS) telecommunications networks in particular with high-speed downlink packet access (HSDPA) schemes. The underlying idea of HSPDA is to increase the achievable data rates for a particular user through a combination of spreading code re-use across transmit antennas and higher-order modulation schemes. However, the code re-use inevitably results in high levels of interference at the mobile receiver, even under non-dispersive channel conditions.

In order to tackle such high interference levels, MIMO receivers based on the aposteriori probability (APP) detector have been proposed. In order to deal with dispersive channels (and hence to avoid sequence estimation) it is necessary to precede such an APP detector with a space-time channel equalizer, followed by a de-spreading operation which allows the APP to perform joint detection of bits transmitted from multiple antennas but corresponding to a single spreading code only, thereby resulting in a significant reduction in computational complexity.

More recently, a multi-stage partial parallel interference canceller (MS-PPIC) has been proposed as an alternative to the APP detector within the above-described receiver structure. Such interference cancellation (SIC) schemes have been considered for many years in the context of multi-user detection for the CDMA uplink.

When using high-order modulations, known MIMO receivers experience problems. For example, the MS-PPIC based detector is manageable in complexity, but provides poor performance for higher order modulations. On the other hand, the APP detector becomes too complex to implement due to its exponential growth in computational complexity.

Specifically, in the known MIMO receiver based on an APP detector but including also a space-time equaliser and a turbo decoder, the computational complexity of the detector grows exponentially both with the number of transmit antennas and with the modulation scheme. The APP (a posteriori probability) detector essentially compares the despread and pre-whitened received signal vector with all possible candidates (all possible symbol combinations from all transmitter antennas). Then the APP detector calculates soft outputs for the most likely transmitted symbol vector in the form of log-likelihood ratios (LLRs). With increasing numbers of transmitter antennas and modulation orders the number of possible candidates for the transmitted symbol vector, and hence the computational complexity, grows exponentially (2^{N}^{_{T}}^{*M} istates with NT transmitter antennas and M bits per symbol). This exponential growth in complexity makes implementations for MIMO with high-order modulations impractical (such as the case of four transmit and four receive antennas (4×4 antennas) using a 16-QAM or 64-QAM or higher-order Quadrature Amplitude Modulation (QAM) schemes).

Furthermore, the computational complexity of a MIMO detector has a significant effect on both the area (and therefore price) of the integrated circuit that would include the MIMO detector, and also its power consumption (which relates to battery lifetime). These characteristics are important, especially for high speed transmissions to the user equipment in MIMO HSDPA (Multiple-Input Multiple Output—High Speed Downlink Packet Access mode) for UMTS.

### SUMMARY OF THE INVENTION

An example of the present invention is a method of communication of data in a mobile telecommunications network involving at a transmitter first grouping data into a first sequence of bits and a second sequence of bits. There is then a step of modulating a signal with the bits of the first sequence so that the bits of the first sequence have a first level of communication error protection provided by the modulation and with the bits of the second sequence so that the bits of the second sequence have a second level of communication error protection provided by the modulation less than the first level of communication error protection. The signal is then transmitted. At a receiver, estimates of the bits of the first sequence from the signal are detected and contributions to the signal corresponding to the estimates are determined and cancelled from the signal so as to produce a modified signal. Estimates of the bits of the second sequence are then detected from the modified signal.

In some embodiments, at the transmitter, to handle higher order modulations, bit groups are encoded dependent on the level of protection provided by the modulation scheme. Bits which are to be given equivalent protection by the modulation scheme are encoded together in one block. In this way, in the receiver, the well-protected bits can be detected and their interference cancelled independently of the less-protected bits. Each data stream is detected (including being decoded) separately as 4-QAM symbols, and therefore with low computational complexity, even when the transmitted modulation scheme is 16-QAM, 64-QAM, 256-QAM or higher. This is achievable without loss of performance, in terms of bit error rate (BER) and frame error rate (FER).

In MIMO systems, this approach avoids the problem of known approaches of exponential growth in detector complexity with higher order modulation schemes such as 16-QAM and 64-QAM.

### BRIEF DESCRIPTION OF THE DRAWINGS

An example embodiment of the present invention will now be described with reference to the drawings, in which:

FIG. 1 is a diagram illustrating cancellation of single bits from a 16QAM constellation,

FIG. 2 is a diagram illustrating receiving circuitry to receive signals subject to Layered Encoding,

FIG. 3 is diagram illustrating the receiver of the receiving circuitry shown in FIG. 2,

FIG. 4 is a diagram illustrating a MS-PPIC detector,

FIG. 5 is a diagram illustrating 16-QAM modulation as an aggregate of 2 interdependent 4-QAM modulations,

FIG. 6 is a diagram illustrating a transversal filter which is part of an equaliser, and

FIG. 7 is a diagram illustrating selection of coefficients for the equaliser.

### DETAILED DESCRIPTION

In a 4 Quadrature Amplitude Modulation or 4 Quadrature Phase Shift Keying modulation scheme, bits corresponding to each symbol are allocated the same amount of energy and are therefore given the same amount of protection by the modulation scheme. In higher order modulation schemes such as 16-QAM, 64-QAM or 256-QAM, the modulated bits are not equally protected. The inventors realised that this fact can be made use of to introduce a layered encoding scheme, whereby bits which are given equivalent protection by the modulation scheme are encoded together in one block.

This allows us to first detect and decode the bit blocks which are well-protected by the modulation scheme, and subsequently subtract their contribution from the received signal in order to reduce the interference for the remaining less-protected bit blocks.

In this way, the received 16/64/256-QAM modulated signal can be treated as the sum of separately encoded 4-QAM data-streams which can be detected sequentially with any 4-QAM detection algorithm. Therefore even very high-order modulations like 256-QAM become feasible, since the computational complexity per information bit stays constant and does not grow exponentially as in the known receivers.

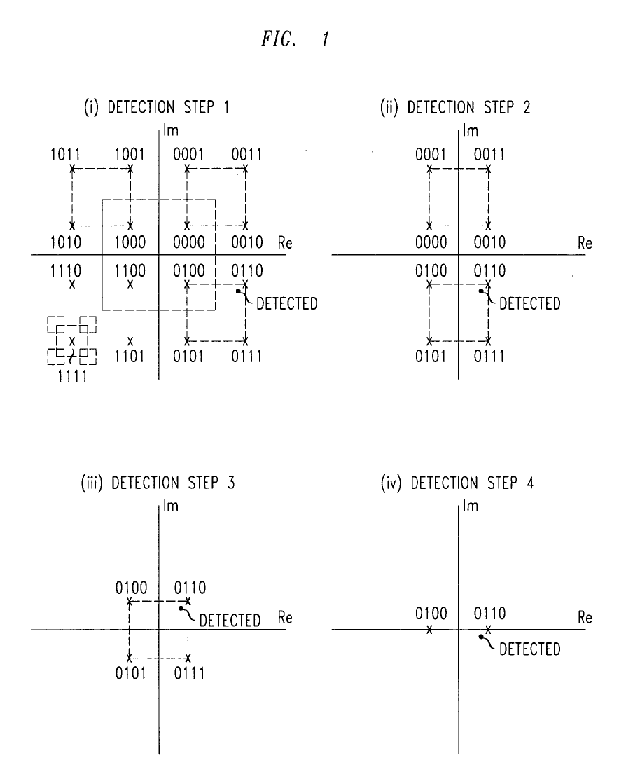

FIG. 1 illustrates the process of bit-cancellation from a 16-QAM modulated symbol (which of course has four bits b_{k,0}⁽ⁿ⁾, b_{k,1}⁽ⁿ⁾, b_{k,2}⁽ⁿ⁾, b_{k,3}⁽ⁿ⁾). In this case bits b_{k,0}⁽ⁿ⁾ & b_{k,1}⁽ⁿ⁾, of each symbol are the most reliable bits and would be encoded as one block, i.e. bit stream. The remaining bits b_{k,2}⁽ⁿ⁾ & b_{k,3}⁽ⁿ⁾ of each symbol would be encoded as a separate lower reliability bit stream.

The basic detection process for 16-QAM would work as follows:
1. Detect high reliability bit stream (bits b1 & b2 of 16-QAM)
2. Calculate & cancel interference of high reliability bit stream [symbol] reduce 16-QAM to 4-QAM
3. Detect low reliability bit stream (bits b3 & b4 of 16-QAM)
   MIMO Transmission

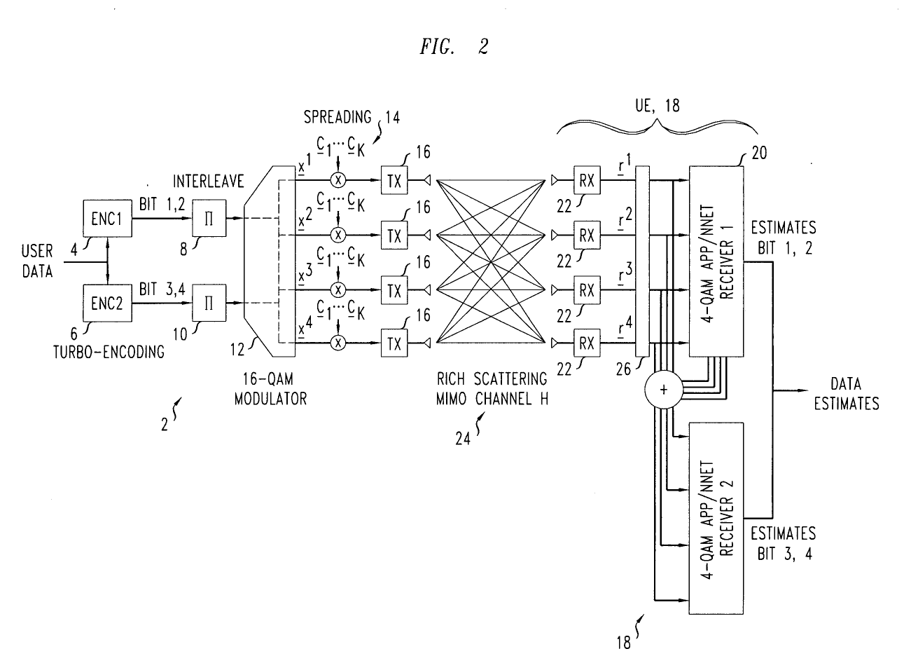

FIG. 2 illustrates the system overview for the multiple-input multiple-output (MIMO) link with 16-QAM modulation, including transmitter and receiving circuitry.

At the transmitter 2, user data is encoded in encoders 4,6 using layered encoding scheme as described below, and then interleaved by interleavers 8,10. The coded data stream is de-multiplexed into N_{T} sub-streams, corresponding to the N_{T} transmit antennas. Each sub-stream is then modulated by a 16QAM modulator 12 on to NK 16-QAM symbols and subsequently spread by spreading stage 14 by a factor Q via a set of K orthogonal spreading codes prior to transmission by transmit antennas 16. Each transmitted spread stream then occupies N symbol intervals. Also note that the same set of K codes are re-used across all transmit antennas. Therefore, the MIMO propagation environment, which is assumed to exhibit significant multipath, plays a major role in achieving signal separation by receiving circuitry 18.

Layered Encoding at the Transmitter

For a so-called Gray-mapped 16-QAM constellation, each symbol xₖ⁽ⁿ⁾(t) is given by

$${x}_{k}^{( n )} ( t ) = 2 \{ - {b}_{k , 0}^{( n )} ( t ) - {jb}_{k , 1}^{( n )} ( t ) \} + \{ - {b}_{k , 0}^{( n )} ( t ) {b}_{k , 2}^{( n )} ( t ) - {jb}_{k , 1}^{( n )} ( t ) {b}_{k , 3}^{( n )} ( t ) \} \qquad ( 1 )$$

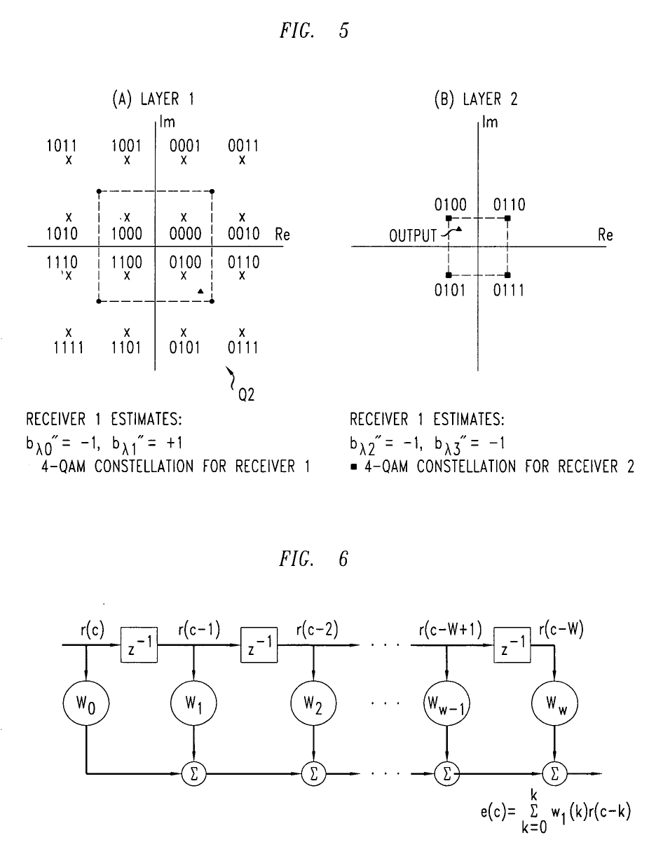

as a function of encoded bits b_{k,0}⁽ⁿ⁾, b_{k,1}⁽ⁿ⁾, b_{k,2}⁽ⁿ⁾, b_{k,3}⁽ⁿ⁾ε{−1, +1}. The corresponding constellation is illustrated in FIG. 5(a). As can be seen, for such high-order constellations, the Euclidean distance is not the same for all modulated bits. This implies that the modulation scheme affords different levels of protection to different bits. For the Gray mapped 16-QAM constellation of FIG. 5, it is clear that b_{k,0}⁽ⁿ⁾ and b_{k,1}⁽ⁿ⁾ are equally better protected than b_{k,2}⁽ⁿ⁾ and b_{k,3}⁽ⁿ⁾.

The feature of layered encoding is exploited by the receiving circuitry 18, whereby the well-protected bits b_{k,0}⁽ⁿ⁾(t) and b_{k,1}⁽ⁿ⁾(t) are detected and decoded first. Due to the greater Euclidean distance associated with these bits, they can be estimated reliably using a 4-QAM detector which is part of a 4-QAM receiver 20, treating the signal contributions from the remaining bits as interference. The contribution of the estimated bits is subsequently cancelled from the received signal. This significantly reduces the interference for the remaining less-protected bits b_{k,2}⁽ⁿ⁾(t) and b_{k,3}⁽ⁿ⁾(t), which are only then detected and decoded.

In order for the well-protected and less-protected bits to be detected and decoded separately, it is required that they are also encoded separately at the transmitter 2. This is indicated in FIG. 2, where the user data is split into two classes and encoded/interleaved independently. The encoded bits of class-1 correspond to b_{k,0}⁽ⁿ⁾(t) and b_{k,1}⁽ⁿ⁾(t), while the encoded bits of class-2 correspond to b_{k,2}⁽ⁿ⁾(t) and b_{k,3}⁽ⁿ⁾(t). The bits are then mapped on to 1 6-QAM symbols according to Equation (1). For 64-QAM, the procedure is essentially the same, except that three classes are considered, according to the three levels of protection provided by the modulation scheme; for 256-QAM four classes are considered, and so on.

In an alternative but otherwise similar embodiment (not shown) to the example embodiment, the performance of the layered encoding scheme is further improved by the encoding rate of each sequence being adapted to the method of detection and channel conditions, for example by puncturing or repetition of bits in the coded sequence. In this way, forward error correction coding is adjusted for each sequence, i.e. layer, so as effect a trade-off between protecting subsequent layers and minimising the error propagation from previous layers. By doing this the bit-error rate of the receiver can be improved without altering the average code rate for a transmitted data block.

We now return to describing the example embodiment.

MIMO Reception

The transmitted signals are received by N_{R} receive antennas 22 after propagation through dispersive radio channels 24 with impulse response lengths of W chips. The received signal vector observed over the t^{th} symbol interval may then be written as

$$\begin{matrix}[ \begin{matrix}{}^{( 1 )} \underline{r} \\ M \\ {}^{( {N}_{R} )} \underline{r}\end{matrix} ] = [ \begin{matrix}{}_{}^{( 1 )}{H}{}_{}^{( 1 )} & Λ & {}_{}^{( 1 )}{H}{}_{}^{( {N}_{T} )} \\ M & O & M \\ {}_{}^{( {N}_{R} )}{H}{}_{}^{( 1 )} & Λ & {}_{}^{( {N}_{R} )}{H}{}_{}^{( {N}_{T} )}\end{matrix} ] {\sum }_{k = 1}^{K} {C}_{k} [ \begin{matrix}{\underline{x}}_{k}^{( 1 )} \\ M \\ {\underline{x}}_{k}^{( {N}_{T} )}\end{matrix} ] + [ \begin{matrix}{}^{( 1 )} \underline{n} \\ M \\ {}^{( {N}_{R} )} \underline{n}\end{matrix} ] \\ or & ( 2 ) \\ \underline{r} = H {\sum }_{k = 1}^{K} {C}_{k} {\underline{x}}_{k} + \underline{n} & ( 3 )\end{matrix}$$

where ^{(m)}rεC^{(QN+W}^{_{−1)×1}} is the signal received at the m^{th} antenna, ^{(m)}H⁽ⁱ⁾εC^{(QN+W}^{_{−1)x}}^{QN} is the channel matrix from the i^{th} transmit antenna to the m^{th} receive antenna, xₖ⁽ⁿ⁾εC^{N}^{ₓ₁} is the symbol sequence [xₖ⁽ⁿ⁾(1) . . . xₖ⁽ⁿ⁾(N)]^{T} transmitted from the n^{th} antenna via the k^{th} spreading code, nεC^{(QN+W}^{_{−1)×1}} is a vector of i.i.d. zero-mean complex Gaussian random variables (i.e. Rₙ=E{nn^{H}}=N₀I) representing noise and inter-cell interference, and finally Ck is the spreading matrix for k^{th} spreading code, cₖεC^{Q}^{_{×1}}, such that

$${C}_{k} {= [ \begin{matrix}{\underline{c}}_{k} & Λ & \underline{0} \\ M & O & M \\ {}_{1}^{}{\underline{0}}{}_{4}^{} & {Λ}_{2} & {}_{4}^{}{{\underline{c}}_{k}}{}_{3}^{}\end{matrix} ]}_{{N}_{T} N Times} ∈ {C}^{{QN}_{T} N \times {N}_{T} N} \qquad ( 4 )$$

The signal vector r is first applied to a processing stage 26 including a channel equalizer, de-spreader, and pre-whitener, then passed to the receiver 20.

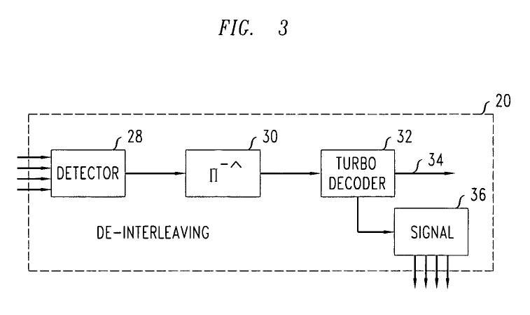

As shown in FIG. 3, the soft outputs computed by a detector 28 in the receiver 20 are then deinterleaved by a deinterleaver 30 and applied to a turbo decoder 32 also in the receiver 20. The turbo decoder 32 generates reliable estimates of the information bits, which are provided to output 34, and estimates of all the transmitted bits, which are provided to signal reconstruction stage 36.

Receiver Circuitry

FIG. 2 discussed above shows the receiver circuitry 18 which exploits the layered encoding scheme for the case of 16-QAM. The layered encoding scheme in conjunction with the 16-QAM transmitter 2 described in the previous section allows the receiving circuitry 18 to treat the transmitted symbols as the aggregate of two inter-dependent 4-QAM constellations. Bits b_{k,0}⁽ⁿ⁾ and b_{k,1}⁽ⁿ⁾ contribute to the first 4-QAM constellation, while bits b_{k,2}⁽ⁿ⁾ and b_{k,1}⁽ⁿ⁾ contribute to the second constellation (with the latter mapping depending on the values of {b_{k,0}⁽ⁿ⁾, b_{k,1}⁽ⁿ⁾} for an overall Gray mapping). As shown in FIG. 5, the 4-QAM receiver 20 first derives estimates of {b_{k,0}⁽ⁿ⁾, b_{k,1}⁽ⁿ⁾} via detection and decoding, cancels their contribution from the received signal, and then derives estimates of {b_{k,2}⁽ⁿ⁾, b_{k,3}⁽ⁿ⁾}. The contributions to the signal due to the first bits and so corresponding to the estimates of the first bits are derived by modulating the bits as was undertaken at the transmitter and including the effect of the channel in known fashion and described in Equation 3 above but without the noise term. It is clearly seen that once the contributions of b_{k,0}⁽ⁿ⁾ and b_{k,1}⁽ⁿ⁾ are subtracted from the 16-QAM constellation, the modulation is reduced to 4-QAM. In the particular example shown in FIG. 5, the first two bits are estimated as −1,+1 (of course, giving bit values of 0,1). The cancellation of the first bits moves the remaining constellation points from the second quadrant (denoted Q2 in FIG. 5(a)) to the centre, as shown in FIG. 5(b). The remaining two bits are then estimated, in this case as −1, −1 (of course, giving bit values of 0,0).

While the layered receiver process has been described for 16-QAM, it can be readily extended to 64-QAM or higher orders, whereby the receiver treats the transmitted symbols as the aggregate of three or more inter-dependent 4-QAM constellations corresponding to three classes or more of reliability.

The proposed scheme can be used to demodulate data sent using a layered encoded high-order modulation scheme such as 16- or 64-QAM, using any type of low complexity 4-QAM detector. The layered encoding scheme can be used with receiving circuitry including known non-iterative (standard) or known iterative 4-QAM receivers 20.

Space-Time Equalization

If optimum space-time detection were used, it would imply joint detection of KN_{T} transmitted symbols per symbol epoch. For 4-QAM modulation, and for dispersive channels with intersymbol interference (ISI) extending over L symbols, this would require a search over a trellis containing 2^{2(L+1)KN}^{_{T}} states. The computational complexity would be prohibitive for typical parameter values.

Note that, in flat fading conditions (L=0) and for K orthogonal codes re-used over the transmit antennas, the number of trellis states reduces to a more realistic value of ₂^{2N}^{_{T}}. Accordingly, an efficient strategy for dealing with dispersive (i.e. non-flat) channels is used of performing detection after a process of space-time equalization which effectively eliminates dispersion.

The equalization process in the equalizer of processing stage 26 inevitably causes noise colouring, which needs to be accounted for in the detection process.

The received signal over N symbol epochs is given by

$$\underline{r} = H {\sum }_{k = 1}^{K} {C}_{k} {\underline{x}}_{k} + \underline{n} = HC \underline{x} + \underline{n} = H \underline{s} + \underline{n} \qquad ( 5 )$$

where s=Cx is the vector of spread symbols. A minimum mean-square error (MMSE) equalizer represents a space-time matrix V which minimizes the term E{∥s−Vr∥²}. It is known that the solution to this problem is given by
   V=RₐH^{H}(HR_{S}H^{H}+Rᵥ)⁻¹ (6)
where R_{S}=E{ss^{H}}=2CC^{H} since E{xx^{H}}=2I for 4-QAM. The equalization process may then be described as

$$\underline{e} = V \underline{r} = VH {\sum }_{k = 1}^{K} {C}_{k} {\underline{x}}_{k} + V \underline{n} ∈ {C}^{{QN}_{T} N} \qquad ( 7 )$$
and clearly results in coloured noise. To avoid excessive computational complexity, space-time equalization is usually performed, over a block of N_{E}<N symbol epochs and repeated N/N_{E} times to cover the entire transmission period. However, this reduction in complexity comes at the expense of degraded performance due to inaccuracies at the edges of the block.
   De-spreading and Pre-whitening

The space-time equaliser removes most of the influence of the channel matrix H. As a result, assuming orthogonal spreading codes, the contribution of symbols transmitted using the k^{th} spreading code can be retrieved at the output of the equalizer via the de-spreading operation of the despreader which is part of processing stage 26.

Even with complete access to channel state information, the space time equalisation can never fully eliminate the influence of the MIMO channel (the zero-forcing equalizer achieves this at the expense of noise enhancement). In other words, VH=D≠I, where D is a non-diagonal distortion matrix.

This has a number of implications with respect to the computation of pre-whitened sufficient statistics for input to the detector, as described next. The output of the equalizer may be written as

$$\underline{e} = V \underline{r} = VH {\sum }_{k = 1}^{K} {C}_{k} {\underline{x}}_{k} + V \underline{n} = D {\sum }_{k = 1}^{K} {C}_{k} {\underline{x}}_{k} + V \underline{n} \qquad ( 8 )$$

and so the de-spreading operation for the k^{th} spreading code may be interpreted as

$$\begin{matrix}{\underline{z}}_{k} = {‖ {\underline{c}}_{k} ‖}^{- 2} {C}_{k}^{H} \underline{e} \\ = {‖ {\underline{c}}_{k} ‖}^{- 2} {C}_{k}^{H} {DC}_{k} {\underline{x}}_{k} + {‖ {\underline{c}}_{k} ‖}^{- 2} {C}_{k}^{H} {DC}_{I , k} {\underline{x}}_{I , k} + {‖ {\underline{c}}_{k} ‖}^{- 2} {C}_{k}^{H} V \underline{n} \\ = {G}_{k} {\underline{x}}_{k} + {T}_{I , k} {\underline{x}}_{I , k} + {T}_{k} \underline{n} \\ = {G}_{k} {\underline{x}}_{k} + {\underline{v}}_{I , k} + {\underline{v}}_{k} ∈ {C}^{{N}_{T} N}\end{matrix} \qquad ( 9 )$$
where C_{1,k}εC^{QN}^{_{T}}^{NxN}^{_{T}}^{N(K-1)} and X_{1,k}εC^{N}^{_{T}}^{N(K-1)} are simply equal to the spreading matrix C and symbol vector x respectively with the elements associated with the k^{th} spreading code removed. The subscript ‘₁’ represents interference. Vector zₖ consists of the equalized and de-spread contributions of N_{T}N symbols transmitted via the kth spreading code over a total of N symbol epochs.

Considering only the N_{T} rows of Eq. (8) corresponding to the t^{th} symbol epoch, we have for t=1 . . . N

$$\begin{matrix}{\underline{z}}_{k} ( t ) = {G}_{k} ( t ) {\underline{x}}_{k} + {T}_{I , k} ( t ) {\underline{x}}_{I , k} + {T}_{k} ( t ) \underline{n} \\ = {B}_{k} ( t ) {\underline{x}}_{k} ( t ) + {\tilde{B}}_{k} ( t ) {\tilde{\underline{x}}}_{k} ( t ) + {T}_{I , k} ( t ) {\underline{x}}_{I , k} + {T}_{k} ( t ) \underline{n} \\ = {B}_{k} ( t ) {\underline{x}}_{k} ( t ) + {\underline{s}}_{I , k} ( t ) + {\underline{v}}_{I , k} ( t ) + {\underline{v}}_{k} ( t ) \\ = {B}_{k} ( t ) {\underline{x}}_{k} ( t ) + {\underline{u}}_{k} ( t ) ∈ {C}^{{N}_{T}}\end{matrix} \qquad ( 10 )$$

where xₖ(t)εC^{N}^{_{T}} is the vector of symbols transmitted during the t^{th} epoch while \tilde{x}ₖ(t)εC^{N}^{_{T}}^{(N-1)} is the vector of symbols not transmitted during the t^{th} epoch via the k^{th} spreading code. Note that while Bₖ(t) represents (spatial) self-interference, s_{1,k}(t) identifies space-time interference at the de-spreader output due to symbols transmitted via the k^{th} spreading code but at other symbol epochs. The imperfect operation of the space-time equalizer also implies that in addition to coloured noise, vₖ, a certain amount of coloured interference, v_{1,k}, (originating from other spreading codes) also “leaks” through to the de-spreader output. Assuming that noise and interference are independent, one may write

$$\begin{matrix}{R}_{{\underline{u}}_{{k}^{( 1 )}}} = E \{ {\underline{u}}_{k} ( t ) {\underline{u}}_{k}^{H} ( t ) \} \\ = 2 \{ {\tilde{B}}_{k} ( t ) {\tilde{B}}_{k}^{H} ( t ) + {T}_{I , k} ( t ) {T}_{I , k}^{H} ( t ) \} + {N}_{o} {T}_{k} ( t ) {T}_{k}^{H} ( t )\end{matrix} \\ since E \{ {\underline{x}}_{I , k} {\underline{x}}_{I , k}^{H} \} = 2 {I}_{{N}_{T} N ( K - 1 )} and E \{ {\tilde{\underline{x}}}_{k} ( t ) {\tilde{\underline{x}}}_{k}^{H} ( t ) \} = 2 {I}_{{N}_{T} ( N - 1 )} . \qquad ( 10 )$$

Accordingly, the pre-whitening with respect to interference and noise is

$$\begin{matrix}{z}_{w , k} ( t ) = {R}_{{\underline{u}}_{k} ( t )}^{- \frac{1}{2}} {\underline{z}}_{k} ( t ) \\ = {R}_{{\underline{u}}_{k} ( t )}^{- \frac{1}{2}} {B}_{k} ( t ) {\underline{x}}_{k} + {R}_{{\underline{u}}_{k} ( t )}^{- \frac{1}{2}} {\underline{u}}_{k} ( t ) \\ = {R}_{{\underline{u}}_{k} ( t )}^{- \frac{1}{2}} {B}_{k} ( t ) {\underline{x}}_{k} ( t ) + {\underline{ɛ}}_{k} ( t )\end{matrix} \\ where E \{ {\underline{ɛ}}_{k} ( t ) {\underline{ɛ}}_{k}^{H} ( t ) \} = {I}_{{N}_{T}} . \qquad ( 12 )$$

This pre-whitening function is performed by the pre-whitener which is part of processing stage 26.

Transversal Filter for Equalization

To avoid inaccuracies at block edges the matrix equaliser described in above Equation (7) is implemented as a transversal filter.

The channel matrix H consists of N_{R}×N_{T} sub-matrices, each of the form of a convolution matrix with the coefficients of the corresponding channel from transmitter antenna n_{T} to receiver antenna n_{R}. The property that the minimum mean square error (MMSE) equalizer matrix V also consists of convolution matrix type sub-matrices, which perform a filter operation in order to equalize each of the channels, is exploited to implement the equalizer using known transversal filters in which the weight coefficients w for each of the channels are derived from the block equalizer sub-matrices ^{(m)}V⁽ⁿ⁾.

As shown in FIG. 7, for a 16-tap equalizer, the coefficients ⁽¹⁾w⁽¹⁾ are obtained by selecting the (Q+W−1)/2^{th} column of the equalizer sub-matrix ⁽¹⁾V⁽¹⁾ of equalizer matrix of size N_{E}=1 symbol, where Q denotes the spreading factor and W the channel length. The example of ⁽¹⁾V⁽¹⁾ in FIG. 7 shows that the strongest elements of ⁽¹⁾w⁽¹⁾ are located in the middle. With increasing distance from the diagonal of the sub-matrix, the coefficients of ^{(m)}w⁽ⁿ⁾ the become smaller, and approach zero for a sufficient number of equalizer taps.

Using this method, the maximum number of tap coefficients obtainable is N_{E}Q. However, since the calculation of V includes a matrix inversion, increasing N_{E} is undesirable due to the high increase in computational complexity.

For the transversal equalizer, the equalized signal for each receiver antenna can be written as

$${}^{{n}_{F}} \underline{ⅇ} = {\sum }_{n = 1}^{{N}_{μ}} conv \{ {}^{( n )} \underline{r} , {}_{}^{( n )}{\underline{w}}{}_{}^{( {n}_{T} )} \} \qquad ( 13 )$$

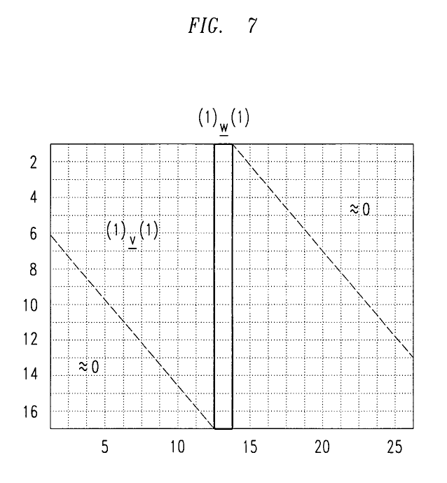

This operation is equivalent to the block equalization in Equation (7) for a block size over all N symbol epochs, assuming the number of taps of the filter are sufficient large, that the coefficient in upper right and lower left triangle of the matrix ^{(m)}V⁽ⁿ⁾ which are not covered by the transversal equalizer approach zero. This operation is also equivalent to that shown schematically in FIG. 6.

For the calculation of the pre-whitening matrix, the matrix equalizer matrix V is modified to match exactly the transversal filter operation. Then, the de-spreading and pre-whitening operation are performed as for the block-based equalization in Equations (8)-(12).

Approximate Modelling of the Equalizer Output

Since the equalizer effectively eliminates the channel dispersion, the remaining intersymbol interference (ISI), which leaks from each symbol in the next, is relatively small in comparison to the distortion from the remaining. Therefore, the contribution from other symbols to the sufficient statistics for the transmitter input is neglected and the N_{T} rows of Eq. (8) corresponding to the i^{th} symbol epoch are written as

$$\begin{matrix}{\underline{z}}_{k} ( t ) \approx {B}_{k} ( t ) {\underline{x}}_{k} ( t ) + {T}_{1 , k} ( t ) {\underline{x}}_{1 , k} + {T}_{k} ( t ) \underline{n} \\ = {B}_{k} ( t ) {\underline{x}}_{k} ( t ) + {\underline{v}}_{1 , k} ( t ) + {\underline{v}}_{k} ( t )\end{matrix} \qquad ( 14 )$$

where v_{kI,k}(t) is the remaining interference from the other spreading codes and vₖ(t) is coloured noise. The resulting correlation of interference and noise is

$$\begin{matrix}{R}_{{\underline{v}}_{k}} ( t ) = E \{ {\underline{x}}_{1 , k} ( t ) {\underline{x}}_{1 , k}^{11} ( t ) \} + E \{ {\underline{v}}_{k} ( t ) {\underline{v}}_{k}^{11} ( t ) \} \\ = 2 {T}_{1 , k} ( t ) {T}_{1 , k}^{11} ( t ) \} + {N}_{o} {T}_{k} ( t ) {T}_{k}^{11} ( t )\end{matrix} , \qquad ( 15 )$$

and it is this which is used instead of Equation (10) to pre-whiten according to Equation (12).
The Detector

One option as to the detector 28 to use in receiver 20 (see FIG. 3) is to use a known APP detector. The APP detector is basically a maximum likelihood detector which generates soft outputs in form of LLRs (Log-Likelihood Ratios).

Another option is a low complexity detector, namely a MS-PPIC detector. This detector can offer similar performance as the APP detector, at only about 20% of the computational complexity. Despite its low complexity, a receiver including the MS-PPIC detector is able to outperform an APP based receiver in dispersive channels, and also in combination with the layered encoding scheme.

These two types of detectors are considered in turn below.

A Posteriori Probability (APP) Detector

Consider pre-whitened sufficient statistics of the form
z_{w}=Ax+ε (16)
where xεC^{N}^{_{T}} is the vector of transmitted symbols and AεC^{N}^{_{T}}^{xN}^{_{T}} is the transformation matrix. Under the assumption that the elements of the additive disturbance vector are independent identical distributed (i.i.d.) zero-mean complex Gaussian random variables of unit variance (i.e. E{εε^{H}}=I), the likelihood function or conditional probability density of z_{w} may be written as

$$\begin{matrix}f ( {\underline{z}}_{w} \vert \underline{x} ) = {\prod }_{i = 1}^{{N}_{T}} f ( {[ {\underline{z}}_{w} ]}_{i} \vert \underline{x} ) \\ = {\prod }_{i = 1}^{{N}_{T}} \frac{1}{π} exp \{ - {\vert {[ {\underline{z}}_{w} ]}_{i} - {[ A \underline{x} ]}_{i} \vert}^{2} \} \\ = {π}^{- {N}_{T}} exp \{ - ‖ {\underline{z}}_{w} - A \underline{x} ‖ {}^{2} \}\end{matrix}$$

With the availability of sufficient statistics z_{w}, a detector is in a position to make a hypothesis x₀ regarding the transmitted symbols. The probability that this hypothesis is correct is equal to the probability, P{x₀|z_{w}}, that x₀ was indeed transmitted given z_{w}. The maximum a posteriori probability (MAP) detector is defined as that which minimizes the probability of an incorrect hypothesis:

$$\begin{matrix}{\underline{\hat{x}}}_{MAP} = arg {max}_{\underline{x}} P \{ \underline{x} \vert {\underline{z}}_{w} \} \\ = arg {max}_{\underline{x}} \frac{P \{ \underline{x} \vert {\underline{z}}_{w} \}}{f ( {\underline{z}}_{w} ) d {\underline{z}}_{w}} \\ = arg {max}_{\underline{x}} \frac{f ( {\underline{z}}_{w} \vert \underline{x} ) ⅆ {\underline{z}}_{w} P \{ \underline{x} \}}{f ( {\underline{z}}_{w} ) ⅆ {\underline{z}}_{w}} \\ = arg {max}_{\underline{x}} f ( {\underline{z}}_{w} \vert \underline{x} ) P \{ \underline{x} \} \\ = arg {max}_{\underline{x}} \frac{P \{ \underline{x} \}}{{π}^{{N}_{T}}} exp \{ - {‖ {\underline{z}}_{w} - A \underline{x} ‖}^{2} \} \\ {\underline{\hat{x}}}_{MAP} = arg {min}_{\underline{x}} \{ {‖ {\underline{z}}_{w} - A \underline{x} ‖}^{2} - ln ( P \{ \underline{x} \} ) \}\end{matrix} \qquad ( 17 )$$

where P{x} is a priori probability of x.

$$ln ( P \{ \underline{x} \} ) == \frac{1}{2} {\underline{b}}^{T} {\underline{Λ}}_{a} ( \underline{b} ) \qquad ( 18 )$$

In the absence of such a priori information, the MAP detector degenerates into the maximum likelihood (ML) detector.

Soft outputs for the i^{th} bit of the symbol vector x may be derived in the form of log-likelihood ratios (LLR) at the output of the MAP detector

$$\begin{matrix}Λ ( {b}_{i} ) = ln \frac{P \{ {b}_{i} = + 1 \vert {\underline{z}}_{w} \}}{P \{ {b}_{i} = - 1 \vert {\underline{z}}_{w} \}} = ln \frac{{\sum }_{\underline{x} \vert {b}_{i} = + 1} P \{ \underline{x} \vert {\underline{z}}_{w} \}}{{\sum }_{\underline{x} \vert {b}_{i} = - 1} P \{ \underline{x} \vert {\underline{z}}_{w} \}} \\ = ln \frac{{\sum }_{\underline{x} \vert {b}_{i} = + 1} f \{ {\underline{z}}_{w} \vert \underline{x} \} P \{ \underline{x} \}}{{\sum }_{\underline{x} \vert {b}_{i} = - 1} f \{ {\underline{z}}_{w} \vert \underline{x} \} P \{ \underline{x} \}} \\ = ln \frac{{\sum }_{\underline{x} \vert {b}_{i} = + 1} {π}^{- {N}_{T}} exp \{ - {‖ {\underline{z}}_{w} - A \underline{x} ‖}^{2} \} P \{ \underline{x} \}}{{\sum }_{\underline{x} \vert {b}_{i} = - 1} {π}^{- {N}_{T}} exp \{ - {‖ {\underline{z}}_{w} - A \underline{x} ‖}^{2} \} P \{ \underline{x} \}} \\ Λ ( {b}_{i} ) = ln \frac{{\sum }_{\underline{x} \vert {b}_{i} = + 1} exp \{ - {‖ {\underline{z}}_{w} - A \underline{x} ‖}^{2} + ln P \{ \underline{x} \} \}}{{\sum }_{\underline{x} \vert {b}_{i} = - 1} exp \{ - {‖ {\underline{z}}_{w} - A \underline{x} ‖}^{2} + ln P \{ \underline{x} \} \}}\end{matrix} \qquad ( 19 )$$

Equation (19) represents what is commonly known as the a posteriori probability (APP) detector. Comparison of Eqs. (18) and (19) indicate that the signs of the above LLR values are equivalent to minimum probability of error (MAP) bit estimates.

As can be seen, the expression for the LLR is not computationally friendly and involves divisions, logarithms and exponentials The computation of the LLR can be simplified by exploiting the max-log approximation which states that In(e^{δ}^{₁}+e^{δ}^{₂}+Λ+e^{δ}^{ₙ})˜max(δ₁,δ₂,Λδₙ). Then the max-log-APP detector may be written as:

$$Λ ( {b}_{i} ) \approx {max}_{\underline{x} \vert {b}_{i} = + 1} \{ - {‖ {\underline{z}}_{w} - A \underline{x} ‖}^{2} + ln P \{ x \} \} - {max}_{\underline{x} \vert {b}_{i} = - 1} \{ - {‖ {\underline{z}}_{w} - A \underline{x} ‖}^{2} + ln P \{ x \} \} \approx {min}_{\underline{x} \vert {b}_{i} = - 1} \{ {‖ {\underline{z}}_{w} - A \underline{x} ‖}^{2} - ln P \{ x \} \} - {min}_{\underline{x} \vert {b}_{i} = + 1} \{ {‖ {\underline{z}}_{w} - A \underline{x} ‖}^{2} - ln P \{ x \} \} \qquad ( 20 )$$

Multi-Stage Parallel Interference Canceller

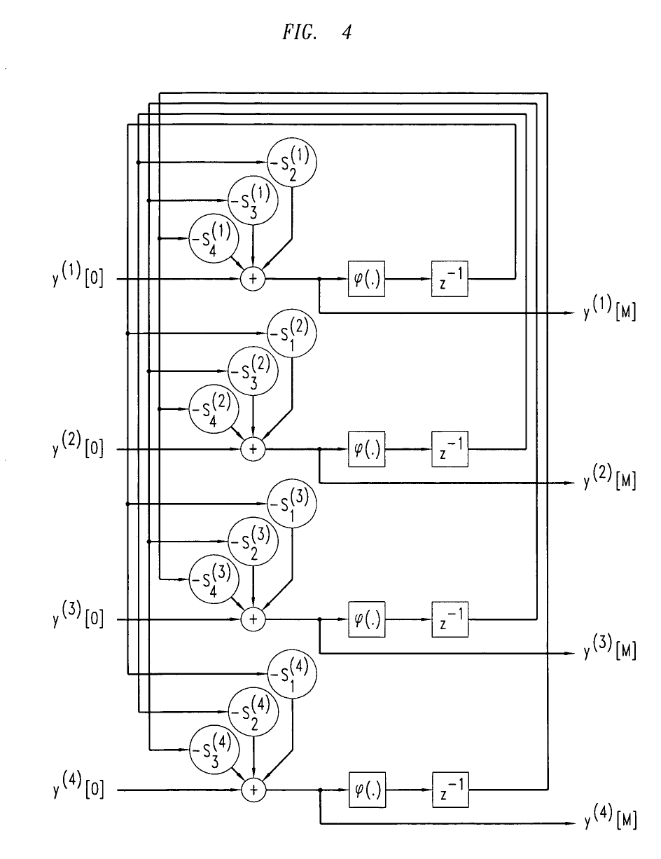

The multi-stage partial parallel interference canceller (MS-PPIC) detector is considered here as an alternative to APP-type detection in the context of MIMO downlink. The MS-PPIC detector is shown in FIG. 4. It operates in an iterative manner, initialised by matched filter outputs (with or without channel equalizer) and generates high quality soft outputs based on the nonlinear cancellation behaviour.

Having computed the set of pre-whitened sufficient statistics z_{w,k}(t) for k=1 . . . K and t=1 . . . N, these vectors can be individually applied to the detector. Consider
z_{w}=Ax+ε (21)
where xεC^{N}^{_{T}} is the vector of transmitted symbols, AεC^{N}^{_{T}}^{N}^{_{T}} is the transformation matrix and E{εε^{H}}=I. Performing matched filtering and normalizing we have

$$\begin{matrix}\underline{y} = {Δ}^{- 1} {A}^{H} {\underline{z}}_{w} \\ = {Δ}^{- 1} {A}^{H} A \underline{x} + {Δ}^{- 1} {A}^{H} \underline{ɛ} \\ = {Δ}^{- 1} R \underline{x} + \underline{η}\end{matrix} \qquad ( 22 )$$
where R=A^{H}A, Δ=diag{R} and E{ηη^{H}}=Δ⁻¹RΔ^{-H}.

The matched filter output may then be written in the form

$$\begin{matrix}\underline{y} = \underline{x} + {Δ}^{- 1} ( R - Δ ) \underline{x} + \underline{η} \\ = \underline{x} + {Δ}^{- 1} {R}^{′} \underline{x} + \underline{η} \\ = \underline{x} + S \underline{x} + \underline{η}\end{matrix} \qquad ( 23 )$$

where, given that R^{t} and S both have zero diagonals, it is clear that the term Sx represents the interference contributions which need to be cancelled. The sufficient statistics of Eq. (5.3) are input to the MS-PPIC and may be viewed as the 0^{th} stage output of the detector. Denoting the n^{th} element of y as y⁽ⁿ⁾ and the n^{th} row of S as s(n)H, we then have

$$\begin{matrix}{y}^{( n )} [ 0 ] = {y}^{( n )} \\ = {x}^{( n )} + {\underline{s}}^{( n ) H} \underline{x} + {η}^{( n )} \\ = {x}^{( n )} + {v}^{( n )} [ 0 ]\end{matrix} \qquad ( 24 )$$
and it immediately follows that cancellation at the m^{th} stage of the detector should be of the form

$$\begin{matrix}{y}^{( n )} [ m ] = {y}^{( n )} [ 0 ] - {\underline{s}}^{( n ) H} f \{ \underline{\hat{x}} [ m - 1 ] \} \\ = {x}^{( n )} + {\underline{s}}^{( n ) H} ( \underline{x} - f \{ \underline{\hat{x}} [ m - 1 ] \} ) + {η}^{( n )} \\ = {x}^{( n )} + {v}^{( n )} [ m ]\end{matrix} \qquad ( 25 )$$
where f{\hat{x}_{[m-1}]} is in general a non-linear function of tentative estimates, \hat{x}_{[m-1}], derived in the previous stage. This is illustrated schematically in FIG. 4.

One could ignore the non-linearity and simply use the tentative estimates \hat{x}_{[m-1}] directly in a linear cancellation process. It has been shown that (under certain constraints on the eigenvalues of S) the resulting linear MS-PIC converges to the MMSE joint-detector as the number of stages approaches infinity [ ]. At the other extreme, one could choose the function f{•} to be a mapping to the 4-QAM alphabet (i.e. a threshold operation). Such hard cancellation would perform well if and only if there was a high level of confidence regarding the reliability of tentative estimates \hat{x}_{[m-1}].

In order to deal with cases where the tentative estimates are unreliable, one may instead use the expected value of the tentative estimates \hat{x}_{[m-1}] in the cancellation process.
Since y⁽ⁿ⁾[m−1]=x⁽ⁿ⁾+v⁽ⁿ⁾[m−1]
then \hat{x}⁽ⁿ⁾[m−1]=y⁽ⁿ⁾[m−1]
assuming that the noise+interference term v⁽ⁿ⁾ is Gaussian distributed, it can readily be shown that

$$\begin{matrix}f \{ {\underline{\hat{x}}}^{( n )} [ m - 1 ] \} ≡ E \{ Re ( {\underline{\hat{x}}}^{( n )} [ m - 1 ] ) \} + j E \{ Im ( {\underline{\hat{x}}}^{( n )} [ m - 1 ] ) \} \\ ≡ E \{ {\underline{\hat{b}}}_{0}^{( n )} [ m - 1 ] \} + j E \{ {\underline{\hat{b}}}_{1}^{( n )} [ m - 1 ] \} \\ ≡ tanh \{ \frac{1}{2} Λ ( {\underline{\hat{b}}}_{0}^{( n )} [ m - 1 ] ) \} + \\ j tanh \{ \frac{1}{2} Λ ( {\underline{\hat{b}}}_{1}^{( n )} [ m - 1 ] ) \} \\ ≡ tanh \{ {α}^{( n )} [ m ] Re ( {\underline{y}}^{( n )} [ m - 1 ] ) \} + \\ j tanh \{ {α}^{( n )} [ m ] Im ( {\underline{y}}^{( n )} [ m - 1 ] ) \}\end{matrix} \qquad ( 26 )$$
where Λ(•) is the log-likelihood ratio and

$${α}^{( n )} [ m ] = \frac{2}{{σ}_{{v}^{( n )} [ m - 1 ]}^{2}} \qquad ( 27 )$$
can be viewed as an antenna-dependent “softness” factor for the m^{th} stage. As can be seen from (5.4), α⁽ⁿ⁾[m] can be readily computed for the first stage:

$${α}^{( n )} [ 1 ] = \frac{2}{E \{ {\vert {\underline{s}}^{( n ) H} \underline{x} + {η}^{( n )} \vert}^{2} \}} = \frac{2}{2 {\underline{s}}^{( n ) H} {\underline{s}}^{( n )} + {R}_{n , n}^{- 1}} \qquad ( 28 )$$
with R_{n,n} the n^{th} diagonal element of R. The computation of α⁽ⁿ⁾[m] is more involved for subsequent stages. Consequently, α⁽ⁿ⁾[1] may be used for all stages M=1 . . . . M Though sub-optimal, this strategy should not significantly degrade performance in the SNR range of interest.

Finally, the M stages of parallel cancellation may be described as

for m = 1Λ]M (stages)

$\underline{ξ} = \underline{y} [ m - 1 ] ∈ {C}^{{N}_{T}}$
for n = 1Λ N_{T} (antennas)

y⁽ⁿ⁾[m] = y⁽ⁿ⁾[0]

$- {s}^{( n ) H} \{ tanh \{ Γ Re ( \underline{ξ} ) \} + j tanh \{ Γ Im ( \underline{ξ} ) \} \}$

ξ⁽ⁿ⁾ = y⁽ⁿ⁾[m]

end

end

| | |
|---|---|
| where | |
| Γ = 2[diag{2SS^{H}} + Δ⁻¹]⁻¹ | (29) |

is a diagonal matrix of the “softness” factors. Essentially, at each stage the contributions due to other antennas are removed from the elements of y[0]. The contributions at the m^{th} stage are constructed from “soft symbols” derived in the previous (m−1)^{th} stage as well as those derived most recently in the current stage. Log-likelihood ratios may be computed after the last stage, where as a result of multiple stages of cancellation y⁽ⁿ⁾[M]˜x⁽ⁿ⁾+η⁽ⁿ⁾ and so

$$\begin{matrix}Λ ( {b}_{0}^{( n )} ) = \frac{4 Re ( {y}^{( n )} [ M ] )}{{R}_{n , n}^{- 1}} & & Λ ( {b}_{1}^{( n )} ) = \frac{4 Im ( {y}^{( n )} [ M ] )}{{R}_{n , n}^{- 1}}\end{matrix} \qquad ( 30 )$$

Complexity Comparison

TABLE 1
COMPLEXITY COMPARISON (Senario: 4 × 4 Antennas, 1/3 rate coding

| | | APP + | MS-PPIC + |
|---|---|---|---|
| Modulation | | Layered | Layered |
| Scheme | Original APP | Encoding | Encoding |
| 4-QAM | 2048 | 2048 | 544 |
| 16-QAM | 524*10³ | 2048 | 544 |
| 64-QAM | 134*10⁶ | 2048 | 544 |
| 256-QAM | 34*10⁹ | 2048 | 544 |

Table 1 shows a complexity comparison in multiplications per symbol period between comparative examples of a known receiver including an APP detector and the two proposed schemes based on reception of layered encoding (involving an APP detector and an MS-PPIC detector respectively). Each is considered in a scenario where there are 4 transmit antennas, 4 receive antennas and 1 bit of data becomes 3 encoded bits including error check data (denoted ⅓ rate coding). The computational complexity in the case of the known receiver including an APP detector (denoted “original APP” in the Table) grows exponentially. Therefore, when high-order modulations are used, the complexity becomes clearly prohibitive. On the other hand, it will be seen that with the proposed reception of layered encoding, the complexity per information bit stays constant for all modulations schemes. Additionally, the proposed scheme involving the MS-PPIC based detector reduces the complexity by a further 75% and allows high-speed MIMO receivers, capable of dealing with even 256-QAM modulation at very low computational complexity.

It is seen from the table that the proposed reception of layered encoding can have particular advantages in avoiding the exponential growth in complexity that occurs in known APP based receivers using higher order modulation. The receiver based on the APP detector and reception of layered encoding has an advantage that existing MIMO chips, can be reused to provide extremely high modulation schemes for MIMO HSDPA.

The receiver based on a MS-PPIC detector and reception of layered encoding has an advantage that computational complexity of the MS-PPIC detector is only 20% of the known APP-based receiver, and can achieve even better performance.

The reception of layered encoding scheme is not restricted to these two types of detectors, but can be used in conjunction with any 4-QAM capable detector.

Exploiting the layered encoding scheme in the proposed receivers (as described above) allows the use of higher order modulations (16-, 64-, 256-QAM) without exponential increase in computational complexity whilst maintaining good bit error rate/frame error rate (BER/FER) performance.

1. A method of communication of data in a mobile telecommunications network, the method comprising:
at a transmitter:
grouping data into a first sequence of bits and a second sequence of bits,
modulating a signal with the bits of the first sequence so that the bits of the first sequence have a first level of communication error protection provided by the modulation and with the bits of the second sequence so that the bits of the second sequence have a second level of communication error protection provided by the modulation less than the first level of communication error protection, and transmitting the signal; and
at a receiver:
detecting estimates of the bits of the first sequence from the signal, determining contributions to the signal corresponding to the estimates of the bits of the first sequence,
cancelling the contributions from the signal so as to produce a modified signal,
detecting estimates of the bits of the second sequence from the modified signal.

2. A method according to claim 1, including the steps of: at the transmitter encoding each of the sequences of bits by including error check data into the sequence of bits before modulation, and at the receiver decoding the estimates of the bits of each sequence so as to retrieve the data.

3. A method according to claim 2, in which the sequences are encoded with different levels of further protection provided by error check data.

4. A method according to claim 1, in which the modulation provides a 16 Quadrature Amplitude Modulation signal, and the bits of the first sequence comprise the first two bits of a four bit binary data sequence, and the bits of the second sequence comprise the other two bits of said binary data sequence.

5. A method according to claim 1, in which at the transmitter the grouping of the data also provides a third sequence of bits, the bits of the third sequence also being used to modulate the signal so that the bits of the third sequence have a third level of communication error protection less than the second level of communication error protection, and
at the receiver also determining and cancelling contributions to the signal corresponding to the estimates of the bits of the second sequence from the modified signal so as to produce a further modified signal and
detecting estimates of the bits of the third sequence from the further modified signal.

6. A method according to claim 4, in which modulation provides a 64 Quadrature Amplitude Modulation signal, and the bits of the first sequence comprise the first two bits of a six bit 6 binary data sequence, the bits of the second sequence comprise the second two bits of said binary data sequence, and the bits of the third sequence comprise the last two bits of said binary data sequence.

7. A method according to claim 1, in which the detecting steps are undertaken by circuitry including an a prior probability (APP) detector.

8. A method according to claim 1, in which the detecting steps are undertaken by circuitry including a Multi-Stage Partial Parallel Interference Cancellation (MS-PPIC) detector.

9. A method according to claim 1, in which the detecting steps are undertaken by a detector giving soft estimates of bits and a decoder giving estimates of the bits based on the soft estimates.

10. A method according to claim 1, in which the signal is processed into a Multiple Input Multiple Output (MIMO) signal for transmission by a space-time processor at the transmitter.

11. A mobile telecommunications network operative to communicate data, the network comprising a transmitter and a receiver,
the transmitter comprising
a selector operative to group data into a first sequence of bits and a second sequence of bits,
a modulator operative to modulating a signal with the bits of the first sequence so that the bits of the first sequence have a first level of communication error protection provided by the modulation and with the bits of the second sequence so that the bits of the second sequence have a second level of communication error protection provided by the modulation less than the first level of communication error protection, and
a transmitting stage operative to transmit the signal,
the receiver comprising:
a detector operative to detect estimates of the bits of the first sequence from the signal,
a canceller operative to determine and cancel contributions to the signal corresponding to the estimates of the bits of the first sequence from the signal so as to produce a modified signal,
a detector operative to detect estimates of the bits of the second sequence from the modified signal.

12. A method according to claim 11, in which the detector comprises a decoder.

13. A mobile telecommunications transmitter operative to transmit data and comprising:
a selector operative to group the data into a first sequence of bits and a second sequence of bits,
a modulator operative to modulating a signal with the bits of the first sequence so that the bits of the first sequence have a first level of communication error protection provided by the modulation and with the bits of the second sequence so that the bits of the second sequence have a second level of communication error protection provided by the modulation less than the first level of communication error protection, and
a transmitting stage operative to transmit the signal.

14. A mobile telecommunications transmitter according to claim 13 comprising a base station.

15. A mobile telecommunications transmitter according to claim 13 comprising a mobile user terminal.

16. A mobile telecommunications receiver operative to receive data represented by a signal, the data comprising bits of a first sequence and bits of a second sequence, the signal having been modulated with the bits of the first sequence so that the bits of the first sequence have a first level of communication error protection provided by the modulation and with the bits of the second sequence so that the bits of the second sequence have a second level of communication error protection provided by the modulation less than the first level of communication error protection,
the receiver comprising:
a detector operative to detect estimates of the bits of the first order from the signal,
a canceller operative to determine and cancel contributions to the signal corresponding to the estimates of the bits of the first order from the signal so as to produce a modified signal,
a detector operative to detect estimates of the bits of the second order from the modified signal.

17. A mobile telecommunications receiver according to claim 16 comprising a base station.

18. A mobile telecommunications receiver according to claim 16 comprising a mobile user terminal.
